(19) United States
(12) Patent Application Publication
(10) Pub. No.: US 2006/0182381 A1
(43) Pub. Date: Aug. 17, 2006

(54) Foil display with increased brightness using a retro reflector

(76) Inventor: Tijsbert Mathieu Henricus Creemers, Nijmgen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,967

(22) PCT Filed: Mar. 15, 2004
(86) PCT No.: PCT/IB04/50252

§ 371 Date: Sep. 12, 2005

(30) Foreign Application Priority Data
Mar. 18, 2003 (EP) 03100686.9

(51) Int. Cl. G02F 1/01

(52) U.S. Cl. 385/1

(57) ABSTRACT

A foil display device has a passive plate (4) and a light guide (2) and a flexible foil (3) arranged between them. The foil (3) can selectively be brought into contact with the light guide (2) to decouple light from the light guide (2). Reflecting means (6) are located on the side of the light guide (2) which is opposite the side towards the flexible foil (3). The reflecting means (6) reflects back-scattered light back to the position from where it was scattered and thus enhances the brightness of the display.

The present invention relates to optical color displays, such as Dynamic Foil Displays, and in particular to such displays with enhanced properties of brightness.

An optical display is a display in which each pixel independently modulates light from a light source, such as a backlight, a front light, an illumination light, or a lightguide, to generate an image.

A Dynamic Foil Display (DFD) typically comprises a display panel having a light guide plate acting as an active plate, a passive plate and a flexible scattering foil sandwiched between these plates as well as actuating means, comprising a transparent electrode associated with the flexible foil, a horizontal scan electrode associated with the passive plate and vertical address electrode associated with the active plate, and which work in the following manner. The flexible foil is arranged with a transparent electrode, to which a foil voltage can be applied. Pixels are typically arranged in a matrix configuration, each pixel being located at the intersection of a horizontal scan electrode arranged on the passive plate and a vertical address electrode arranged on the active plate.

Depending on the voltage setup between the scan, address and foil electrodes, electrostatic forces can be created locally forcing the foil either to contact the active or to contact the passive plate, resulting in the pixel being either activated or inactivated, respectively. Thus, each pixel is either in an active, light decoupling state or in an inactive, light blocking state, there is no state in between.

In case a pixel is activated, the flexible foil is locally brought into contact with the light guide plate and light is consequently decoupled out of the light guide plate into the scattering foil where it is scattered in all directions. Some of the light is scattered out of the display, through the passive plate, resulting in a bright pixel.

A DFD of a general type is known from WO99/28890.

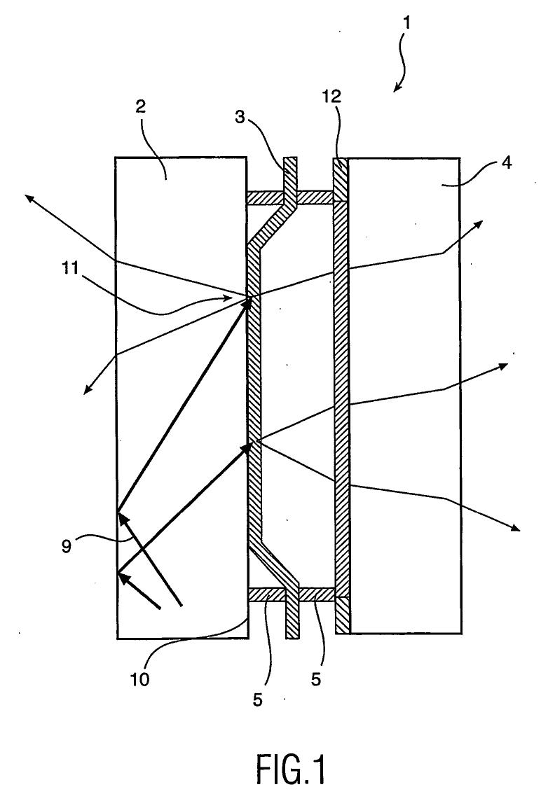

In a color foil display, each pixel is divided into three subpixels. The color of each subpixel is set by a green, red or blue portion of a color filter, respectively. The color filter is usually an absorptive color filter, which means that for example in a red portion of the color filter the green and the blue photons are absorbed and only the red are transmitted. Such a display is shown in FIG. 1.

However, when the light is scattered in all directions in the scattering foil, approximately half the light is naturally back-scattered through the light guide in the direction opposite to a viewer. This means that approximately half the light is “lost”, in the sense that only about half the possible brightness of the display is achieved. Hence it is for example difficult to provide bright enough images for use in conditions of sunshine. Consequently, there is a need for improved optical color display devices in which the above problems are alleviated.

The problems related to back-scattering are substantially alleviated by the optical display device according to claim 1. The appended subclaims provide preferred embodiments of the invention.

The basic idea of the invention is to reflect the light which is back-scattered from each pixel back to the same pixel using a reflecting means.

According to the invention, an optical electronic information display device comprises a light guide, a flexible element and actuating means to bring one or more portions of the flexible element into contact with a first side of the light guide, wherein reflecting means are provided adjacent to a second side of the light guide opposite the first side and arranged to reflect light incident from the first side of the light guide back essentially in the incident direction.

This is advantageous since the reflected back-scattered light improves the brightness of the display.

The flexible element may comprise a scattering foil.

According to an embodiment of the invention the display is divided into pixels, light rays are scattered from the pixels towards the reflecting means and the reflecting means are arranged to reflect an incident light ray back to the same pixel from where it was scattered. This has the advantage of making it possible to use when a color filter is arranged between the passive plate and the flexible element. The reflecting means suitably comprises a retro reflector.

The retro reflector preferably comprises a number of slanted surfaces. This has the advantage of making it easy to reflect the light in the correct direction.

According to one embodiment of the invention the slanted surfaces are arranged in tent-like structures with a top angle of approximately 90°. This gives the advantage of an efficient reflection of the light rays.

The retro reflector can comprise at least one vertical surface which lies in a plane perpendicular to the slanted surfaces. This gives the advantage of limiting the displacement of the reflected light rays and thus preventing that light is reflected back to a place too far away from where it was incident.

According to an alternative embodiment of the invention the slanted surfaces are arranged in groups of four where each group has a corner shape. This is advantageous since it provides efficient reflection.

The reflecting means can be made of a reflective metal. This is an easy and efficient way of giving the reflecting means good reflecting properties.

The display device may be a dynamic foil display.

These and other aspects of the invention will be apparent from and elucidated with reference to the embodiments described hereinafter.

FIG. 1 is a schematic side view of a part of an optical electronic display device according to the state of the art,

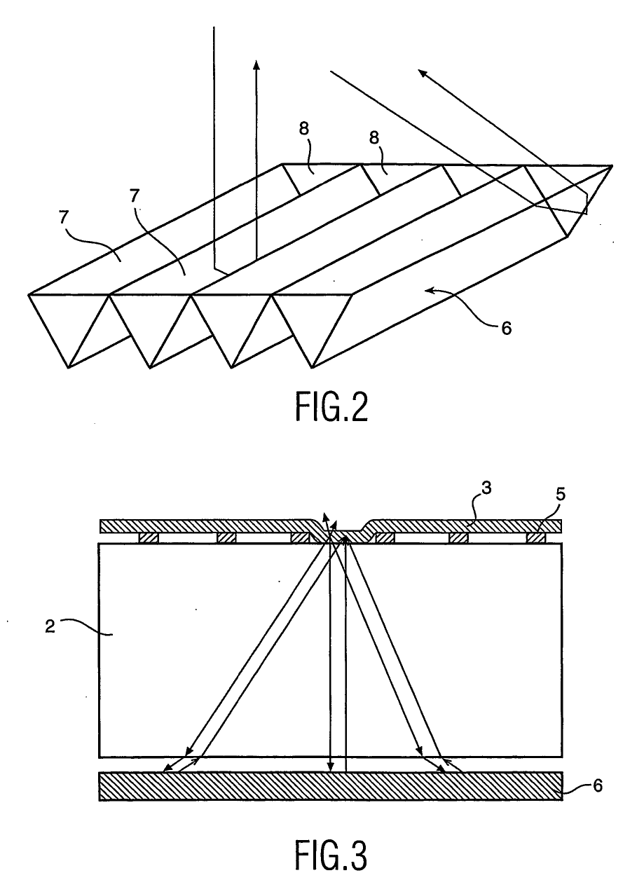

FIG. 2 is a perspective view of a portion of a retro reflector (not on scale for reasons of clarity),

FIG. 3 is a schematic side view of a part of an optical electronic display device with a retro reflector according to the invention,

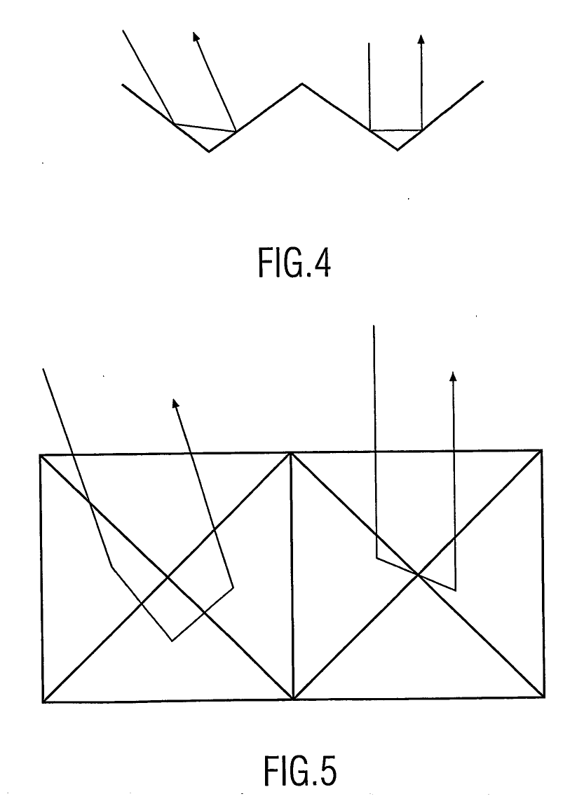

FIG. 4 is a side view of an alternative embodiment of a retro reflector, and

FIG. 5 is a top view of the retro reflector in FIG. 4.

The known optical electronic display device 1 in FIG. 1 comprises a light guide 2, a flexible element in the form of a scattering foil 3, a passive plate 4 and spacers 5. The light guide 2 functions as an active plate. A color filter 12 is located on the side of the passive plate 4 facing the scattering foil.

A light ray 9 incident on the inner surface 10 of the light guide 2 is subject to total internal reflection in the pixels where the scattering foil 3 is not in contact with the light guide 2. Where the scattering foil 3 is—as shown in FIG. 1—brought into contact with the light guide 2 by actuating means, in the manner as disclosed above in reference to the state of the art, the incident light 9 is coupled out of the light guide 2 and scattered in all directions by the scattering foil 3. In some events, such as with reference number 11 in FIG. 1, most of the light is back-scattered into the light guide 2 and only a small amount is scattered towards the passive plate 4 and out of the display. This back-scattering leads to a loss of brightness of the display.

For at least alleviating this drawback of the prior art the optical electronic information display device according to the invention is provided with a retro reflector. A retro reflector is a reflector that reflects an incident light beam in a parallel direction to the direction in which it was incident. A retro reflector 6 is illustrated in FIG. 2, comprising a number of slanting surfaces 7 and a number of vertical surfaces 8. The positioning of the retro reflector in a device according to the invention is shown in FIG. 3, which also illustrates some of the components of FIG. 1 with the same reference numerals. As seen the retro reflector is positioned on the side of the light guide 2 opposite to its side facing the foil 3. As is shown in FIG. 3, the retro reflector reflects the back-scattered light towards the sub-pixel (corresponding to the surfaces of the foil 3 and light guide 2 in mutual contact) from which it was scattered. The light is coupled out of the light guide in the same direction and from essentially the same position as if it had not been back-scattered at all. In this manner the brightness of the display is enhanced, since a greater part of the light is coupled out of the light guide in the direction of the viewer. The parallax effects will be minimized since the light is reflected back to the same sub-pixel.

As shown in FIG. 2, the incident light is for instance reflected against two of the slanting surfaces 7 (shown to the left in FIG. 2) or against two of the slanting surfaces 7 and one of the vertical surfaces 8. The light rays are slightly displaced and travel along a direction parallel to the incident direction, which means that they will be redirected to approximately the same position from where they were back-scattered.

The retro reflector shown in FIG. 2 has a tent-like structure with a top angle of 90°. It is preferably made of a reflective metal material. Assuming that each pixel is 200 μm wide, the width of each tent-like structure in the retro reflector is 200 μm. This means that the depth of the tent-like structure, or reflector prism is 200 μm. The vertical surfaces 8 reflect the incident light rays in two dimensions.

Most of the incident rays will go through three reflections, one against a vertical surface 8 and two against the slanted surfaces. This is shown to the right in FIG. 2.

Some of the incident rays will only go through two reflections on the slanted surfaces. The acceptable angle of these rays determines the necessary spacing of the vertical surfaces. This acceptable angle is in turn determined by the pixel length, the thickness of the light guide and the depth of the reflector prism. The standard pixel length is 600 μm and, as mentioned earlier, the depth of the reflector prism is 200 μm. A common thickness for the light guide is 2 mm.

Assuming that the light over a distance of two times the thickness of the light guide, i.e. 2*2000 μm=4000 μm, may exceed the length of one pixel, i.e. 600 μm, the following relationship applies:
n*sin(θ_{glass})=sin(θₐᵢᵣ),
n=1.5 and assuming that the path length a ray travels in air is at least 200 μm→1.5*(600/4000)=X/200,
where X is the vertical spacing needed.

In the above example this yields X=45. Thus, the spacing between the vertical surfaces in this exemplifying embodiment of the invention should be 45 μm to keep the rays from travelling outside the pixel when reflected back from the retro reflector.

An alternative embodiment of a retro reflector is shown in FIGS. 4 and 5. The reflector in FIGS. 4 and 5 has a corner shape for each pixel that reflects the incident light back in the same direction as shown in the figure. It is preferably made of a reflective metal material.

The protective scope of the invention is not limited to the embodiments shown. The invention resides in each and every novel characteristic and each and every combination of characteristic features. Moreover, reference numerals in the claims are not to be construed as limiting their protective scope.

1. An optical electronic information display device comprising:
a light guide (2),
a flexible element (3) and
actuating means to bring one or more portions of the flexible element (3) into contact with a first side of the light guide (2), characterized by
reflecting means (6) which are provided adjacent to a second side of the light guide (2) opposite the first side and arranged to reflect light incident from the first side of the light guide back essentially in the incident direction.

2. An optical electronic information display device according to claim 1, wherein the flexible element (3) comprises a scattering foil (3).

3. An optical electronic information display device according to claim 1, wherein the display device is divided into pixels, light rays are scattered from the pixels towards the reflecting means (3) and the reflecting means (3) is arranged to reflect an incident light ray back to the same pixel from where it was scattered.

4. An optical electronic information display device according to claim 1, wherein the reflecting means (6) comprises a retro reflector (6).

5. An optical electronic information display device according to claim 4, wherein the retro reflector (6) comprises a number of slanted surfaces (7).

6. An optical electronic information display device according to claim 5, wherein the slanted surfaces (7) are arranged in tent-like structures with a top angle of approximately 90°.

7. An optical electronic information display device according to claim 5, wherein the retro reflector (6) comprises at least one vertical surface (8) which lies in a plane perpendicular to the slanted surfaces (7).

8. An optical electronic information display device according to claim 5, wherein the slanted surfaces are arranged in groups of four where each group has a corner-shape.

9. An optical electronic information display device according to claim 1, wherein the reflecting means (6) are made of a reflective metal.

10. An optical electronic information display device according to claim 1, the display device being a dynamic foil display.
